(19) United States
(12) Patent Application Publication
(10) Pub. No.: US 2002/0001441 A1
(43) Pub. Date: Jan. 3, 2002

(54) HYBRID CABLE HAVING BOTH AN OPTICAL FIBER AND A MULTIFILAMENT TWISTED AND DRAWN ELEMENT

(76) Inventor: FRANCISCO J. AVELLANET, CORAL GABLES, FL (US)

Correspondence Address: DAVID P GORDON ESQ, 65 WOODS END ROAD, STAMFORD, CT, 06905

(21) Appl. No.: 09/290,774

(22) Filed: Apr. 13, 1999

(51) Int. Cl. G02B 6/44

(52) U.S. Cl. 385/104; 385/103; 385/105; 385/106

(57) ABSTRACT

A hybrid cable includes an optical fiber and a multifilament twisted and drawn or swaged electrical conductor. According to one embodiment, the filaments of the multifilament twisted and drawn or swaged electrical conductor are twisted about the optical fiber and then drawn through one or more dies or swaged. In a second embodiment, a metal tube is drawn through one or more dies, an optical fiber is provided in the tube, and then the tube is drawn again with the optical fiber contained therein to result in a drawn filled tube having a central optical fiber. The drawn filled tube is then used a central filament and a plurality of conductive filaments are twisted and about the central filament and the twisted assembly is then drawn or swaged to result in a hybrid cable. In a third embodiment, a multifilament twisted and drawn or swaged cable is formed with a central filament harder than the surrounding the filaments. The central filament is subsequently withdrawn from the surrounding filaments and a twisted and drawn or swaged tube results. An optical fiber is then fed into or pulled through the center of the twisted and drawn or swaged tube to provide a hybrid cable. According to fourth and fifth embodiments, a hybrid cable is provided which includes at least one multifilament twisted and drawn or swaged cable and at least one optical fiber which are arranged parallel within a sheath.

### BACKGROUND OF THE INVENTION

1. Field of the Invention

This invention relates broadly to optical fiber cables. More particularly, this invention relates to optical fibers combined with one or more electrical conductors in a hybrid cable.

2. State of the Art

Fiber optic cables are increasingly used to transmit video, voice, and data signals. Some advantages of using optical fibers in the transmission of communication signals include an immunity of optical signals to electromagnetic interference. Additionally, optical fibers are relatively lightweight, flexible, and can carry high bandwidth.

However, many telecommunication signals are still transmitted over electrical conductor cables, e.g. copper lines. Hence, there is a need for hybrid cables having both optical fibers and electrical conductors, and such cables have been recently developed. In general, known hybrid cable constructions utilize discrete conductors and optical fibers housed together in a common insulative sheath.

The hybrid cables of the art have several drawbacks. First, the electrical conductors are relatively less flexible than the optical fibers and, as such, a hybrid cable cannot be snaked through tortuous paths to the same extent as a pure optical fiber. Second, hybrid cables tend to have a substantial amount of dead space within the insulative sheath resulting from the non-concentric configuration of all of the circular electrical conductors and circular optical fibers within the common sheath. Third, hybrid cables often suffer from lack of tensile strength.

### SUMMARY OF THE INVENTION

It is therefore an object of the invention to provide a hybrid cable having both an optical fiber and an electrical conductor.

It is another object of the invention to provide a hybrid cable which is relatively more flexible than other hybrid cables of the same diameter.

It is a further object of the invention to provide a hybrid cable which attempts to maximize the combined cross-sectional areas of the electrical conductors and optical fibers within the cross-sectional area of an insulative sheath circumscribing the cable.

It is an additional object of the invention to provide a hybrid cable in which the electrical conductor and optical fiber substantially completely fill the insulative sheath.

It is also an object of the invention to provide a hybrid cable which has an optical fiber having greater bandwidth than an optical fiber of known hybrid cables.

In accord with these objects, which will be discussed in detail below, a hybrid cable including at least one optical fiber and at least one electrical conductor is provided. The electrical conductor is preferably a multifilament twisted and drawn or swaged cable. The hybrid cable preferably includes an outer insulative sheath.

According to a first preferred embodiment of the invention, the filaments of the multifilament twisted and drawn or swaged electrical conductor are twisted about a central optical fiber and then drawn through one or more dies or swaged. The filaments are arranged such that when they are drawn or swaged, the compressive forces are directed on neighboring filaments and not directed radially inward toward the optical fiber, thereby preventing deformation of the optical fiber.

According to a second embodiment of the invention, a metal tube is optionally drawn through one or more dies, an optical fiber is provided in the tube, and then the tube is drawn again with the optical fiber contained therein to result in a drawn filled tube having a central optical fiber. The drawn filled tube is then used a core filament and a plurality of conductive filaments are twisted and about the core filament and the twisted assembly is then drawn or swaged to result in a hybrid cable.

According to a third embodiment of the invention, a multifilament twisted and drawn or swaged cable is formed with a central filament harder than the surrounding filaments. The central filament is subsequently withdrawn from the surrounding filaments leaving behind a twisted and drawn or swaged tube with a central opening. An optical fiber is then fed into or pulled through the central opening of the twisted and drawn or swaged tube to provide a hybrid cable.

According to a fourth embodiment of the invention, a hybrid cable is provided which includes at least one multifilament twisted and drawn or swaged cable and at least one optical fiber which together are arranged parallel within a sheath. Preferably, the arrangement is configured in accord with Apollonian circles of fractal geometry.

According to a fifth embodiment of the invention, a hybrid cable is provided which includes at least one conductor wire or cable, at least one optical fiber, and at least one multifilament twisted and drawn support member. The twisted and drawn or swaged cable, in addition to being electrically conductive, provides tensile strength to the hybrid cable.

With the above embodiments, a hybrid cable is provided having increased flexibility relative to a wire, conductive cable, or hybrid cable of the same diameter. In addition, the multifilament twisted and drawn or swaged conductor cable has a smaller diameter than a twisted cable of the same cross-sectional area. Furthermore, the multifilament twisted and drawn or swaged conductor cable has a tensile strength greater than a wire or cable of the same diameter. As a result, hybrid cables constructed from the multifilament twisted and drawn or swaged conductor cable have greater flexibility and greater strength relative to other hybrid cables.

Additional objects and advantages of the invention will become apparent to those skilled in the art upon reference to the detailed description taken in conjunction with the provided figures.

### BRIEF DESCRIPTION OF THE DRAWINGS

FIG. 1 is a cross sectional view of a hybrid cable assembly according to a first embodiment of the invention prior to drawing through reducing dies or swaging;

FIG. 2 is a cross sectional view of the hybrid cable according to the first embodiment of the invention after drawing through reducing dies or swaging;

FIG. 3 is a cross sectional view of a hybrid cable assembly according to a second embodiment of the invention prior to drawing through assembly through reducing dies or swaging;

FIG. 4 is a cross sectional view of the hybrid cable according to the second embodiment of the invention after drawing through reducing dies or swaging;

FIG. 5 is a cross sectional view of a cable assembly according to a third embodiment of the invention;

FIG. 6 is a cross sectional view of a twisted and drawn or swaged tubular cable according to the third embodiment of the invention;

FIG. 7 is a cross sectional view of a hybrid cable according to the third embodiment of the invention;

FIG. 8 is a cross sectional view of a hybrid cable according to a fourth embodiment of the invention; and

FIG. 9 is a cross sectional view of a hybrid cable according to a fifth embodiment of the invention.

### DETAILED DESCRIPTION OF THE PREFERRED EMBODIMENTS

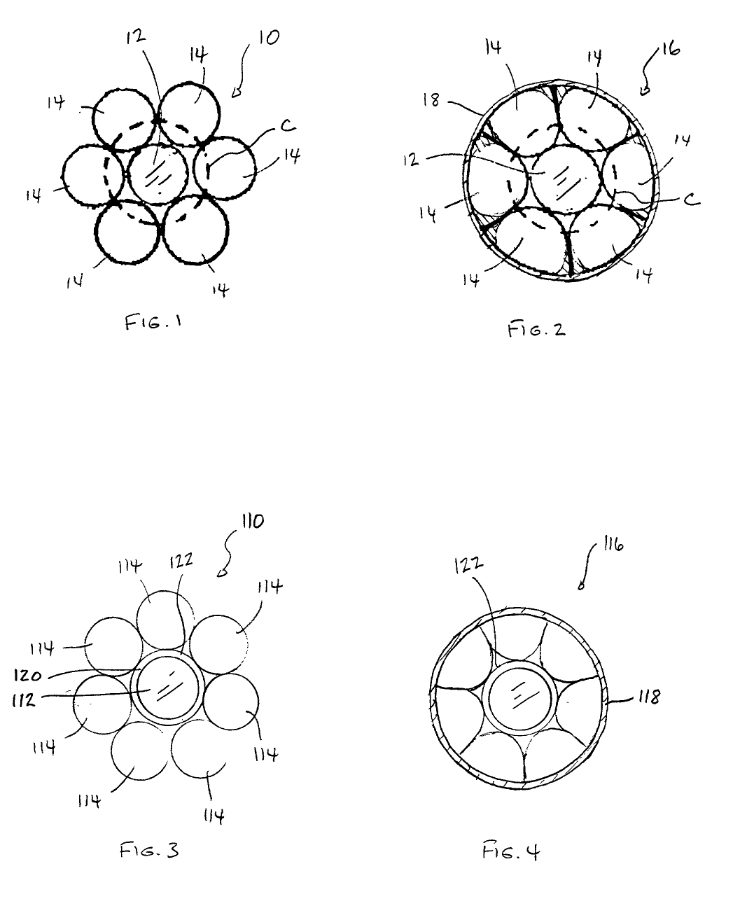

Turning now to FIG. 1, a multifilament rope 10 for a hybrid cable 16 (FIG. 2) according to a first embodiment the invention is shown. The multifilament rope 10 includes a central fiber optic 12 and six outer wires 14 surrounding the fiber optic 12. The fiber optic 12 (also called an optical fiber) is a non-metallic strand or fiber optic bundle and is adapted to transmit light therethrough. Preferably the fiber optic is of a quality such that substantially all the light entering one end of the fiber optic exits the other end of the fiber optic. The fiber optic 12 typically includes a cylindrical glass or polymeric core, a cladding of typically similar material but of typically lower refractive index than the core, and if desired, an outer sheath or jacket for protection.

The outer wires 14 of the multifilament rope 10 are conductive, preferably being made from metal, e.g., copper, silver, gold, or aluminum, or a metal alloy, e.g, steel or nickel-titanium. If desired, the outer wires 14 may be wires made of a first metal and plated with another, typically softer metal. The outer wires 14 are twisted about the optical fiber 12 to form the multifilament rope 10 with the outer wires 14 contacting each other along the dotted circle C illustrated in FIG. 1. The multifilament rope 10 is then pulled through a die using known wire drawing methods and apparatus whereby its diameter is decreased. Preferably, the multifilament rope 10 is successively drawn through dies of decreasing diameter. During the drawing process, the outer wires 14 are provided in a circle of equilibrium; that is, the inward compressive forces that develop during the drawing process are distributed fairly evenly onto the outer wires of the assembly which are held in this equilibrium arrangement by the presence of the central fiber optic 12. As the central fiber optic 12 serves to maintain the outer wires 14 in equilibrium, it is not subject to inward compressive forces and therefore is not distorted or crushed during the drawing process. Referring to FIG. 2, as a result, the outer wires 14, rather than moving inward, are plastically deformed, with the outer wire material yielding and flowing into the interstices (indicating by thatching) outside the circle of equilibrium C to form a first embodiment of the hybrid cable 16 of the invention. After the successive drawing is completed, the cable 16 assumes a substantially circular cross section.

According to the presently preferred embodiment, the multifilament rope is successively pulled through two or more dies of decreasing diameter. The resulting hybrid cable 16 has a diameter which is preferably approximately 25% smaller than the diameter of the multifilament rope 10. Alternatively, the multifilament rope 10 may be swaged to have a substantially circular cross-section and a reduced diameter. The construction of multifilament twisted and drawn or swaged cables is also described in detail in U.S. Ser. Nos. 08/843,405 and 08/856,571, which are hereby incorporated by reference herein in their entireties. The hybrid cable 16 exhibits relatively high flexibility and tensile strength relative to hybrid cables which do not utilize twisted and drawn or swaged constructs. In addition, the hybrid cable can be manufactured in a continuous process to produce cable of any length. A hybrid cable produced in this manner may have a natural curl, which may then be straightened (mechanically or otherwise), and preferably without a level of heat which could detrimentally affect the optical fiber. An insulative jacket or coating 18 is preferably provided over the exterior of the cable 16. It is noted that if an insulative jacket is provided over the fiber optic 12, the fiber optic 12 will be able to withstand additional heat which could be used for the straightening process.

According to an example of the first embodiment, the central core monofilament was approximately 0.011 inch in diameter, and the outer filaments were 0.016 inch in diameter. The multifilament rope was 0.039 inch in diameter and was successively drawn through dies to form a hybrid cable 0.030 inch in diameter.

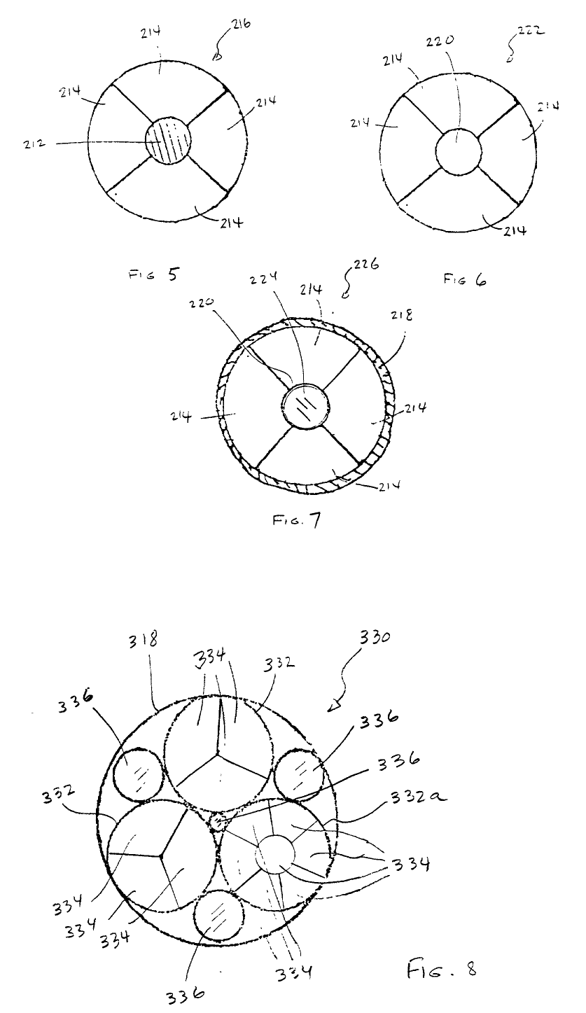

Turning now to FIGS. 3 and 4, a second embodiment of the invention is now described. Referring to FIG. 3, an optical fiber 112 is shown positioned in a flexible metal tube. The metal tube 120 is preferably a stainless steel drawn tube; that is a stainless steel tube which has previously been drawn through one or more dies to reduce its diameter and wall thickness, and increase its flexibility. If desired, the tube 120 may be a metal tube coated with a highly conductive metal such as gold, silver, tin, platinum, copper, or aluminum, substantially as disclosed in U.S. Pat. No. 5,574,260 to Broomall et al., which is hereby incorporated by reference herein in its entirety. After inserting the optical fiber 112 into the tube 120, the tube 120 is preferably drawn again to substantially bring the inner diameter of the tube 120 to the same size as the outer diameter of the optical fiber, securing the tube and optical fiber together and forming a drawn optical fiber filled tube 122. It will be appreciated that the drawn optical fiber filled tube functions as a hybrid ‘cable’, transmitting light through the fiber and electricity through the outer tube. Seven (or more) conductive filaments 114 are twisted about the filled tube 122 to form a multifilament twisted rope 110. The rope 110 is drawn through successive dies, e.g. two dies, or swaged to reduce its diameter and increase its flexibility and tensile strength, as well as integrate the conductive filaments about the filled tube 122 to form the hybrid cable 116. It will be appreciated that the metal tube 120 provides a protective coating over the optical fiber to prevent the optical fiber from being crushed during the drawing or swaging of the multifilament rope 110. The hybrid cable 116 is provided with superior optical bandwidth relative to known optical fibers of the same diameters, presumably due to the additional ‘cladding’ of the drawn tube about the optical fiber. A nonconductive jacket or coating 118 is preferably provided over the outer surface of the hybrid cable 116. The second embodiment of the hybrid cable is particularly useful for applications requiring relatively short discrete lengths of hybrid cables, e.g, under 100 meters.

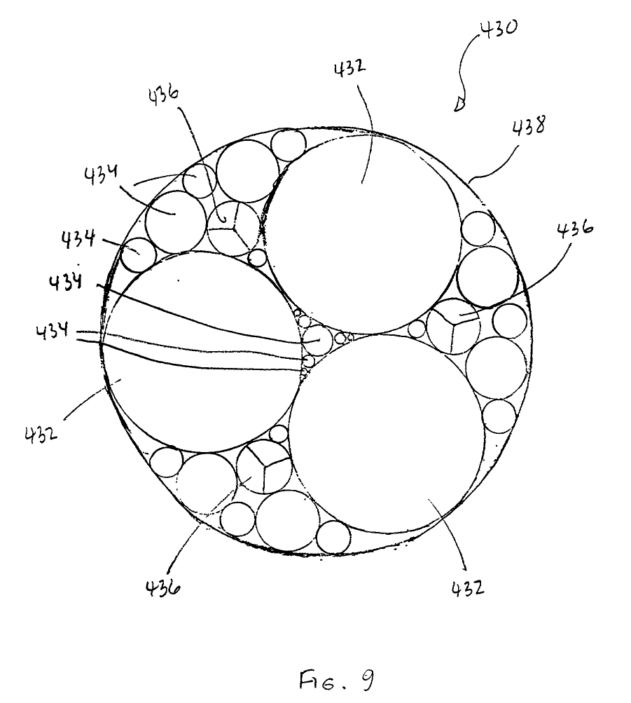

Referring now to FIGS. 5 through 7, a third embodiment of a hybrid cable 226 according to the invention is now described. Referring to FIG. 5, a twisted and drawn or swaged cable 216 is manufactured having a relatively hard central wire mandrel 212, e.g., stainless steel, and four relatively softer conductive metal outer wires 214, e.g., copper. The twisted and drawn or swaged cable 216 is manufactured substantially as described above; i.e., by twisting the outer wires about the central wire to form a multifilament rope and then drawing the rope through one or more dies or swaging the rope to form a cable of reduced diameter. Referring to FIGS. 5 and 6, after drawing or swaging, the central wire mandrel 212 is pulled to withdraw the central wire from the center 220 of the cable, thereby providing a twisted and drawn or swaged tubular cable 222; i.e., a cable having a central opening. If desired, in order to expedite removal of the central wire, the central wire and the outer wires may be subjected to differential temperatures. Referring to FIG. 7, an optical fiber 224 is then thread or pulled through the central hole 220, e.g, by coupling the optical fiber 224 to a trailing end of the pulled central wire 212 when the central wire is removed from the cable. The resulting hybrid cable 226 is preferably provided with an insulative jacket or coating 218. The third embodiment of the hybrid cable is particularly useful for applications requiring relatively short discrete lengths of hybrid cables, e.g, under 100 meters.

Turning now to FIG. 8, a fourth embodiment of a hybrid cable 330 is shown. The hybrid cable 330 includes a plurality of multifilament twisted and drawn or swaged cables 332, each comprising a plurality of conductive wires 334. It will be appreciated that, in this embodiment, the cables 332 do not include a central optical fiber, but may optionally include a central conductive wire, e.g., 332a. Disposed between and around the cables 332 are a plurality of optical fibers 336. The cables 332 and optical fibers 336 are bound together in an insulative jacket or coating 318 to form the hybrid cable 330. The hybrid cable 330 may be continuously formed in any desired length.

It will be appreciated that each of the above embodiments provides a hybrid cable having increased flexibility and torqueability relative to hybrid cables which utilize a conductive wire or non-drawn or swaged cable. Furthermore, hybrid cables incorporating multifilament twisted and drawn or swaged cables have a tensile strength greater than hybrid cables which utilize a wire or cable of the same diameter. As a result, hybrid cables having multifilament twisted and drawn or swaged conductor cables have greater flexibility and greater strength relative to other hybrid cables. In addition, hybrid cables having a multifilament twisted and drawn or swaged conductor cable which surrounds an optical fiber have smaller diameters than hybrid cables having twisted cables of the same cross-sectional area as the drawn of swaged conductor cable surrounding an optical fiber.

Referring now to FIG. 9, a fifth embodiment of a hybrid cable 430 is shown. The hybrid cable 430 includes a plurality of conductors 432, a plurality of optical fibers 434, and a plurality of support members 436, all of which are bound in a jacket or coating 438. The conductors 432 may be solid wires, twisted cables, or twisted and drawn cables. The support members 436 are multifilament twisted and drawn or swaged cables and are utilized for providing the hybrid cable 430 with structural and tensile strength. As such the materials of the support members are not chosen for their conductance, but rather are chosen for their strength. For example, the twisted and drawn or swaged support members 436 may be made from stainless steel and/or nickel-titanium wires. The conductors 432, optical fibers 434, and support members 436 are preferably arranged according to the principles of Apollonian circles to minimize the diameter of the bound hybrid cable 430 for any given number of conductors, optical fibers, and support members, with respect to their relative sizes, or alternatively, to maximize the area of the conductors, fibers, and support members within a given diameter. In addition, the conductors, optical fibers, and support members may run parallel or may be twisted or stranded about each other. The hybrid cable 430 may be continuously formed in any desired length.

It will be appreciated that hybrid cables incorporating a twisted and drawn support member are thereby provided with enhanced tensile strength relative to other hybrid cables.

There have been described and illustrated herein several embodiments of a hybrid cable and methods of making a hybrid cable. While particular embodiments of the invention have been described, it is not intended that the invention be limited thereto, as it is intended that the invention be as broad in scope as the art will allow and that the specification be read likewise. Thus, various aspects of the different embodiments of the invention may be mixed and matched to provide desired results. In addition, while a particular number of filaments have been described with respect to the manufacture of twisted and drawn or swaged cables for the hybrid cables, it will be appreciated that other numbers of filaments may be used. For example, there may be two or more outer filaments in embodiments which utilize a central fiber optic, and two or more total filaments where a central fiber optic is not required. Also, while particular conductive materials have been described for the conductive filaments, it will be appreciated that other materials can be used as well. In particular, nickel-titanium or other superelastic or shape memory alloys may be used. Furthermore, the twisted and drawn or swaged cables may be constructed from a combination of materials to result in a cable have desired relative degrees of conductance, flexibility, and tensile strength, among other properties. In addition, while stainless steel and nickel-titanium have been disclosed for the drawn tube and support members, it will be appreciated that other materials can be used for these elements. Furthermore, wherever a single optical fiber has been shown or described in the hybrid cable, it will be appreciated that it may be replaced by an optical fiber bundle. Moreover, while optical quality fibers made from polymers or glass are preferred, other fibers may be provided in the hybrid cable. Also, while in the first embodiment six outer filaments may be drawn or swaged about a relatively softer optical fiber due to the configurations capability of maintaining an equilibrium of forces, it will be appreciated that other numbers of filaments may be drawn to provide a hollow tube or cable. For example, four filaments may be twisted and drawn or swaged to produce a hollow cable through which one or more optical fibers may be thread. In addition, while particular dimensions have been provided, it will be appreciated that hybrid cables of different dimensions utilizing elements of different dimensions may be created. Also, while a particular number of dies for pulling the respective multifilament rope therethrough has been disclosed with respect to particular embodiments, it will be appreciated that in each embodiment one or more dies may be used. Furthermore, while a preferred drawing or swaging produces a 25% reduction in diameter, other reductions in diameter may be used. It will therefore be appreciated by those skilled in the art that yet other modifications could be made to the provided invention without deviating from its spirit and scope as so claimed.

What is claimed is:

1. A hybrid cable, comprising:
a) at least one polymeric or glass fiber;
b) at least one multifilament twisted and drawn or swaged element; and
c) an insulative jacket or coating surrounding said at least one optical fiber and said at least one multifilament twisted and drawn or swaged element.

2. A hybrid cable according to claim 1, wherein:
said at least one fiber is of optical quality.

3. A hybrid cable according to claim 1, wherein:
said at least one multifilament twisted and drawn or swaged element is comprised of at least one of copper, silver, gold, aluminum, steel, and nickel-titanium.

4. A hybrid cable according to claim 1, wherein:
said at least one fiber is a plurality of fibers, said at least one multifilament twisted and drawn or swaged element is a plurality of multifilament twisted and drawn or swaged elements,
said plurality of fibers and said plurality of multifilament twisted and drawn or swaged elements being in an Apollonian circle arrangement.

5. A hybrid cable according to claim 1, further comprising:
d) at least one conductor,
wherein said at least one conductor has a greater conductance than said at least one multifilament twisted and drawn or swaged element.

6. A hybrid cable according to claim 5, wherein:
said at least one fiber is a plurality of fibers, and said plurality of fibers, said at least one multifilament twisted and drawn or swaged element, and said at least one conductor are in an Apollonian circle arrangement.

7. A hybrid cable according to claim 1, wherein:
said at least one fiber is one fiber and said at least one multifilament twisted and drawn or swaged element is one multifilament twisted and drawn or swaged element, and said one fiber and said one multifilament twisted and drawn or swaged element are coaxial.

8. A hybrid cable according to claim 7, further comprising:
d) a tubular element provided between said one fiber and said one multifilament twisted and drawn or swaged element.

9. A hybrid cable according to claim 8, wherein:
said tubular element has a hardness greater than said fiber.

10. A hybrid cable, comprising:
a) at least one polymeric or glass fiber; and
b) a plurality of metal or metal alloy filaments twisted and drawn or swaged coaxial with and external of said at least one fiber.

11. A hybrid cable according to claim 10, wherein:
said glass fiber has an outer surface and each of said filaments is in contact with said outer surface.

12. A hybrid cable according to claim 10, wherein:
said filaments are selected from one or more of copper, aluminum, silver, gold, steel, and nickel-titanium.

13. A hybrid cable, comprising:
a) a non-metallic central core filament; and
b) a plurality of conductive filaments twisted and drawn or swaged about said non-metallic central core filament.

14. A hybrid cable, comprising:
a) at least one polymeric or glass fiber having an outer surface; and
b) a flexible metal tubular element provided about and in contact with said outer surface of said at least one polymeric or glass fiber.

15. A hybrid cable according to claim 14, wherein:
said tubular element is a drawn tubular element.

16. A hybrid cable according to claim 14, further comprising:
c) a plurality of metal or metal alloy filaments twisted and drawn or swaged coaxial with and external of said tubular element.

17. A method of making a hybrid cable, comprising:
a) twisting a plurality of conductive strands about a core element adapted to transmit light therethrough to form a rope; and
b) drawing the rope through at least one die to form a hybrid cable.

18. A method according to claim 17, wherein:
said hybrid cable has a substantially circular cross section.

19. A method according to claim 17, wherein:
said core element comprises an optical fiber.

20. A method according to claim 17, wherein:
said core element comprises a drawn metal tube having an optical fiber extending therethrough.

21. A method of making a hybrid cable, comprising:
a) providing a core element adapted to transmit light therethrough;
b) arranging a plurality of metal or metal alloy filaments about said core element such that said filaments are in equilibrium, said filaments and core element together forming a rope; and
c) drawing said rope through at least one die to form a hybrid cable.

22. A method according to claim 21, further comprising:
d) straightening said hybrid cable.

23. A method according to claim 22, wherein:
said straightening is mechanically straightening.

24. A method of making a hybrid cable, comprising:
a) providing a metal tube having an inner diameter;
b) inserting a polymeric or glass fiber through said metal tube; and
c) drawing said metal tube with said fiber provided therein through at least one die to reduce said inner diameter of said metal tube.

25. A method according to claim 24, further comprising:
d) after said drawing, twisting a plurality of conductive strands about said metal tube to form a rope; and
e) drawing said rope through at least one die.

26. A method according to claim 24, wherein:
said fiber has an outer diameter, and said drawing comprises drawing until said inner diameter of said metal tube is reduced to be substantially equal to said outer diameter of said fiber.

27. A method according to claim 24, further comprising:
prior to said inserting, drawing said metal tube through at least one die.

28. A method of making a hybrid cable, comprising:
a) twisting a plurality of conductive strands about a central element to form a multifilament rope having a first diameter;
b) drawing the multifilament rope through at least one die to form a cable having a reduced second diameter;
c) removing said central element from said cable to provide said cable with a central opening; and
d) inserting a polymeric or glass fiber into said central opening.
